(19) United States
(12) Patent Application Publication
(10) Pub. No.: US 2012/0284079 A1
(43) Pub. Date: Nov. 8, 2012

(54) RETAIL PRE-PACK OPTIMIZER

(75) Inventors: Andrew VAKHUTINSKY, Norwood, MA (US); Shivaram SUBRAMANIAN, Eddington, ME (US); Yevgeniy POPKOV, Brookline, MA (US); Alex KUSHKULEY, Acton, MA (US)

(73) Assignee: ORACLE INTERNATIONAL CORPORATION, Redwood Shores, CA (US)

(21) Appl. No.: 13/101,604

(22) Filed: May 5, 2011

(51) Int. Cl. G06Q 10/00; G06Q 30/00

(52) U.S. Cl. 705/7.25

(57) ABSTRACT

A system determines an optimized pre-pack configuration with an optimized pre-pack allocation and an optimized pre-pack design. The system receives demand data and constraints and initializes a current pre-pack allocation and a current pre-pack design. For the current pre-pack allocation, the system determines a new pre-pack design by solving a multi-choice integer knapsack problem, and then determines if the new pre-pack design is different than the current pre-pack design. When the new pre-pack design is different than the current pre-pack design, the system determines a new pre-pack allocation and assigns the new pre-pack allocation as the current pre-pack allocation and the new pre-pack design as the current pre-pack design and repeats the determining the new pre-pack design and the determining if the new pre-pack design is different than the current pre-pack design until the new pre-pack design is the same as the current pre-pack design.

### FIELD

One embodiment is directed generally to a computer system, and in particular to a computer system for optimizing retail pre-packs.

### BACKGROUND INFORMATION

A “pre-pack” is a collection of items used in retail distribution. The pre-pack is a group of multiple units of one or more stock keeping units (“SKU”) that can reduce distribution and handling costs, by reducing the amount of material handled at the origin (e.g., a distribution center), destination (e.g., a retail store), and intermediate points (e.g., a warehouse).

For example, apparel retailers typically construct pre-packs of various sizes of a particular style and color of a t-shirt, rather than directly ship loose quantities of each size to stores. There can be multiple pre-pack “types” or “designs”, each having different quantities of individual products and in different relative proportions, and the collection of the different pre-pack types is referred to as an overall pre-pack “configuration.” An example of one pre-pack type is a pre-pack having 5 extra small t-shirts, 10 small t-shirts, 15 medium t-shirts, 15 large t-shirts, and 10 extra large t-shirts. An example of a second pre-pack type is a pre-pack having 10 extra small t-shirts, 15 small t-shirts, 10 medium t-shirts, 10 large t-shirts, and 5 extra large t-shirts. An example of a pre-pack configuration is 10 of the first pre-pack type and 5 of the second pre-pack type.

The pre-packs are configured when the demand forecast for merchandise items becomes known at the store level. At this point, several similar items are grouped to be jointly delivered to the stores by one or more pre-packs to reduce delivery costs. However, there is a certain tradeoff to pre-packs. Specifically, performing such an aggregation while reducing shipping and handling costs tends to increase the mismatch between the required quantity of each individual merchandise at the destination and what is actually shipped (i.e., either an over- or under-allocation), given that there are typically a maximum number of pre-pack types employed.

For example, suppose there is a demand at a store for fifteen t-shirts of size “small” but the pre-pack type contains ten “small” t-shirts. In this example, either ten or twenty units can be delivered to the store, depending on a configuration of one of these pre-packs or two pre-packs, resulting in either an under- or over-allocation of small t-shirts at the store. As a result, the determination of a pre-pack configuration and pre-pack types should be optimized to minimize the total of delivery and misallocation costs subject to various pre-pack constraints.

### SUMMARY

One embodiment is a system that determines an optimized pre-pack configuration with an optimized pre-pack allocation and an optimized pre-pack design. The system receives demand data and constraints and initializes a current pre-pack allocation and a current pre-pack design. For the current pre-pack allocation, the system determines a new pre-pack design by solving a multi-choice integer knapsack problem, and then determines if the new pre-pack design is different than the current pre-pack design. When the new pre-pack design is different than the current pre-pack design, the system determines a new pre-pack allocation and assigns the new pre-pack allocation as the current pre-pack allocation and the new pre-pack design as the current pre-pack design and repeats the determining the new pre-pack design and the determining if the new pre-pack design is different than the current pre-pack design until the new pre-pack design is the same as the current pre-pack design.

### BRIEF DESCRIPTION OF THE DRAWINGS

FIG. 1 is a block diagram of a computer system that can implement an embodiment of the present invention.

FIG. 2 is a flow diagram of the functionality of the pre-pack optimizer module of FIG. 1 when executing an alternating heuristic to determine an optimized pre-pack design in accordance with one embodiment.

FIG. 3 is a flow diagram of the functionality of the pre-pack optimizer module of FIG. 1 to solve the pre-pack design problem of FIG. 2 in accordance with one embodiment.

### DETAILED DESCRIPTION

One embodiment is a computer system that optimizes both the pre-pack types and the pre-pack configuration. The system alternatively and iteratively solves the sub-problems of the pre-pack configuration and the pre-pack types/designs until an optimized overall solution is reached.

In general, a “pre-pack” is a collection of units of various SKUs bundled together, as described above. A pre-pack can be represented as follows: {SKU1: quantity of SKU1, SKU2: quantity of SKU2, SKU3: quantity of SKU3, . . . }. Typically all SKUs from a given pre-pack belong to the same style-color, or to the same style, or to several styles from same class.

A pre-pack “type” is a unique “flavor” of a pre-pack characterized by a certain set of SKUs and a certain set of corresponding unit quantities. A pre-pack “configuration” is a set of unique pre-pack types used as shipment units to allocate a particular style-color (or style, or a group of styles) to all stores.

Pre-pack constraints are certain business constraints on pre-pack types and configurations, such as the total number of units in a pre-pack is within certain min/max or equals certain carton sizes, etc. Constraints can be “hard” or “soft” constraints. Hard constraints are those business rules that must be satisfied (e.g., no more than three pre-pack types must be used in the configuration). Soft constraints are those business rules that must be satisfied to the extent possible. Typically these are equivalent to the objectives and goals of a business (e.g., minimize misallocation to the extent possible).

A feasible pre-pack configuration is a pre-pack configuration that satisfies all pre-pack hard constraints. A pre-pack allocation for a given sku-parent, store, and feasible pre-pack configurations can be represented as follows: {pre-pack type 1: quantity of pre-packs of type 1, . . . , pre-pack type N: quantity of pre-packs of type N}

Embodiments of the present invention perform pre-pack optimization by creating a pre-pack configuration for a given style-color (or style, or a group of styles) that satisfies business constraints (e.g., on the number of unique pre-pack types in pre-pack configuration and on the number of units in a pre-pack configuration) so that the resulting pre-pack configuration can be used to allocate that style-color (or style, or a group of styles) to all stores in such a way that some weighted sum of misallocation (i.e., lost sales, handling costs and markdown losses) is minimized across all stores, while also limiting the number of used unique pre-pack types and the total number of pre-packs allocated, thereby minimizing operational and shipping, and handling costs.

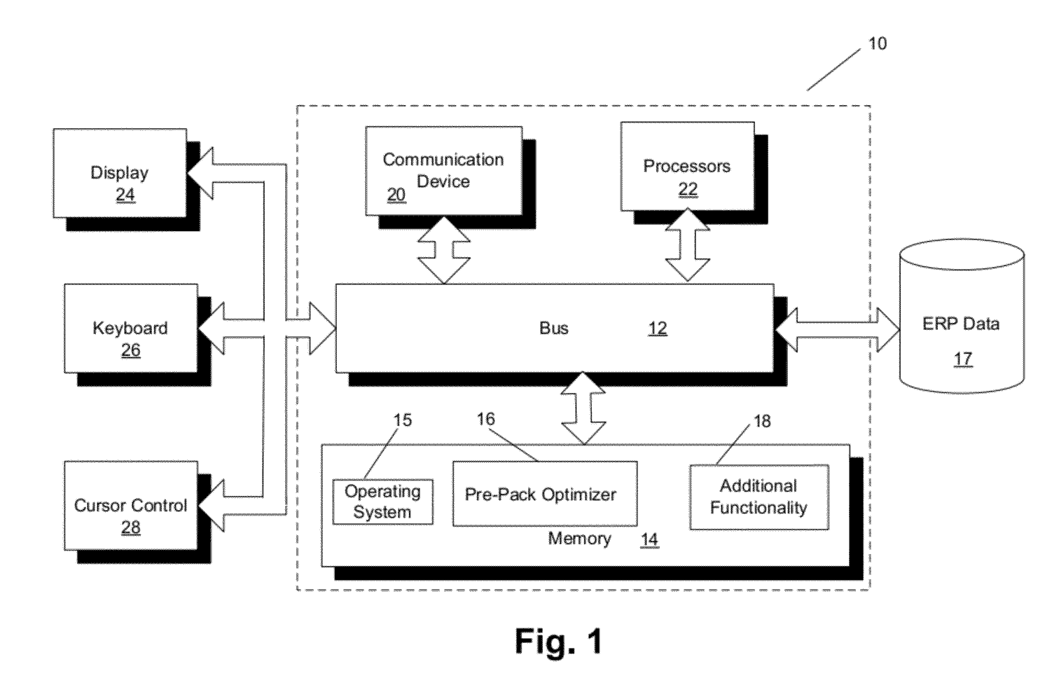

FIG. 1 is a block diagram of a computer system 10 that can implement an embodiment of the present invention. Although shown as a single system, the functionality of system 10 can be implemented as a distributed system. System 10 includes a bus 12 or other communication mechanism for communicating information, and a processor 22 coupled to bus 12 for processing information. Processor 22 may be any type of general or specific purpose processor capable of processing multiple instructions in parallel. In one embodiment, processor 22 is an individual multi-core processor, but may be implemented using multiple individual processors in communication with each other, or any other type of processor or processors that is capable of parallel computing.

System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication device 20, such as a network interface card, to provide access to a network. Therefore, a user may interface with system 10 directly, or remotely through a network or any other method.

Computer readable media may be any available media that can be accessed by processor 22 and includes both volatile and nonvolatile media, removable and non-removable media, and communication media. Communication media may include computer readable instructions, data structures, program modules or other data in a modulated data signal such as a carrier wave or other transport mechanism and includes any information delivery media.

Processor 22 is further coupled via bus 12 to a display 24, such as a Liquid Crystal Display (“LCD”), for displaying information to a user. A keyboard 26 and a cursor control device 28, such as a computer mouse, is further coupled to bus 12 to enable a user to interface with system 10.

In one embodiment, memory 14 stores software modules that provide functionality when executed by processor 22. The modules include an operating system 15 that provides operating system functionality for system 10. The modules further include a pre-pack optimizer module 16 that optimizes pre-pack types and configurations/allocations, as disclosed in more detail below. System 10 can be part of a larger system, such as an overall retail management system or an Enterprise Resource Planning (“ERP”) system. Therefore, system 10 will typically include one or more additional functional modules 18 to include the additional functionality. A database 17 is coupled to bus 12 to provide centralized storage for modules 16 and 18 and store data such as retail pricing and inventory information, other ERP data, etc.

In one embodiment, pre-pack optimizer module 16 receives inputs and generates as outputs an optimized and feasible pre-pack design that includes the design of each of the pre-pack types, and the pre-pack configuration. The inputs can include store-level demands for D stores, for a given set of Q SKUs, specified as a D×Q matrix, and further includes P (variable or fixed number) of pre-packs, pre-pack hard constraints and soft constraints (i.e., objectives and goals). In one embodiment, the input data is in a dense two-dimensional matrix form. In another embodiment, the input data can be in a sparse matrix form that only specifies the non-zero demand values.

The output in one embodiment is a feasible, good-quality pre-pack configuration and pre-pack designs (one solution or a family of solutions for different numbers of pre-pack types used) that satisfies all pre-pack hard constraints (if feasible) and meets soft constraints to the extent possible.

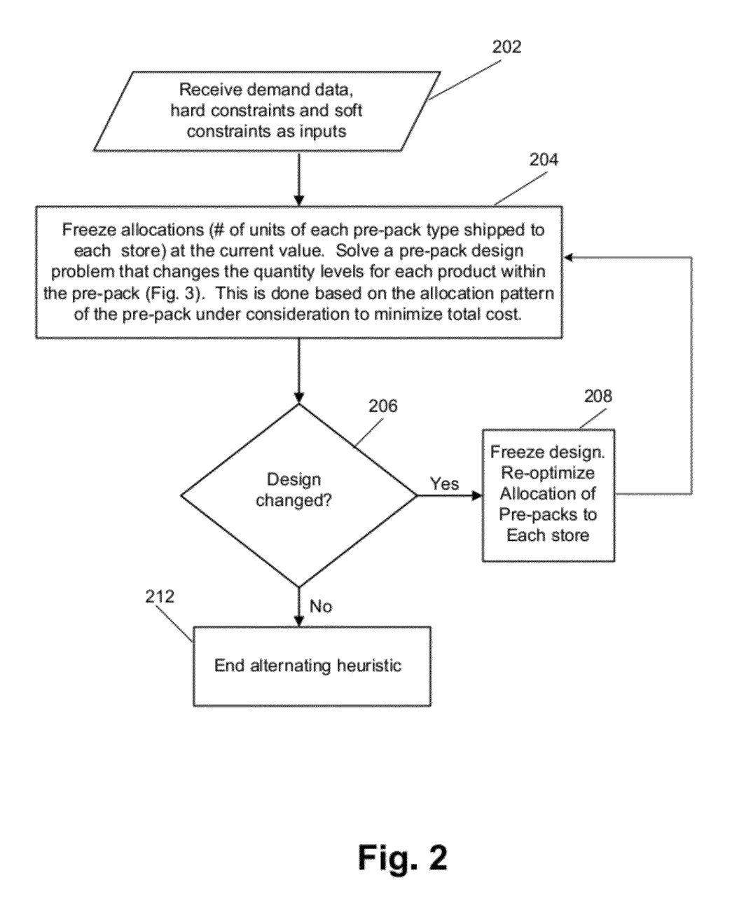

FIG. 2 is a flow diagram of the functionality of pre-pack optimizer module 16 of FIG. 1 when executing an alternating heuristic to determine an optimized pre-pack design in accordance with one embodiment. In the functionality of FIG. 2, there are two sub-problems that are alternatively solved:

(1) The pre-pack design determination based on the current allocation of pre-packs to stores (# of units of each pre-pack type allocated to each store). In one embodiment, the design determination is solved using a Multi-choice Integer Knapsack Algorithm (“MCKNP”).
(2) The allocation (i.e., how pre-packs should be allocated across stores). This solution results in a “score” or goodness of the design from (1) above.

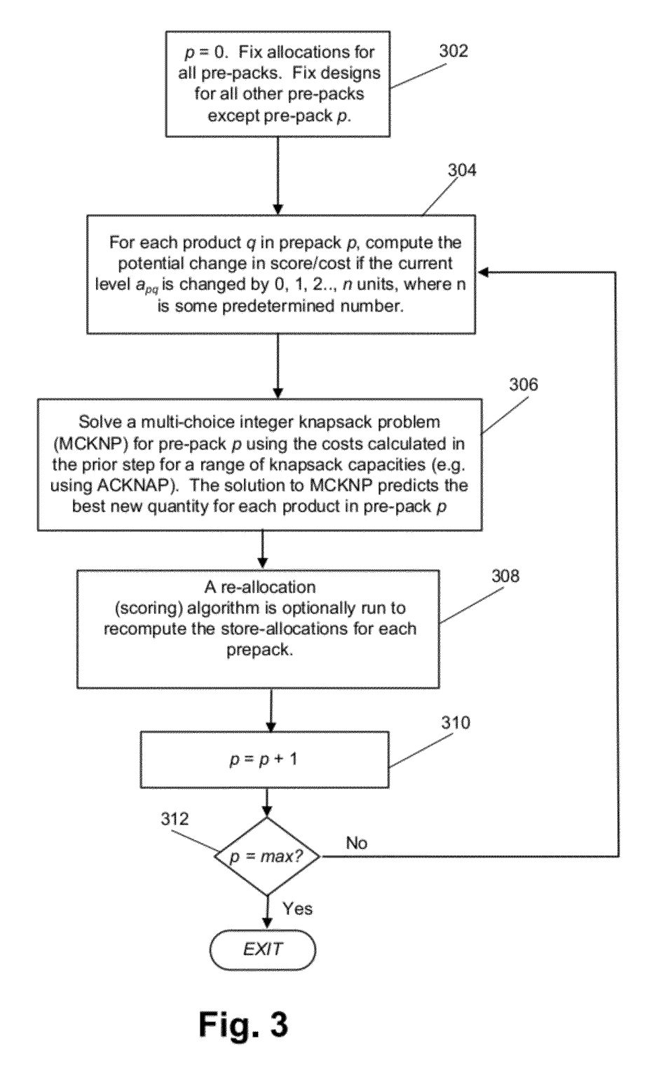

In one embodiment, the functionality of the flow diagram of FIG. 2, and FIG. 3 below, is implemented by software stored in memory or other computer readable or tangible medium, and executed by a single processor or multiple processors in parallel. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software.

At 202, the demand data, hard constraints and soft constraints are received as inputs. In one embodiment, these inputs can be in the form of a matrix. Also received as inputs in one embodiment is the current allocations/configurations and the current pre-pack designs.

At 204, allocations (i.e., the number of units of each pre-pack shipped to each store) is frozen at the current value. The pre-pack design problem based on the current allocation of pre-packs to stores (# of units of each pre-pack allocated to each store) in then solved based of the allocation pattern of the pre-pack under consideration to minimize total cost. The functionality of solving the pre-pack design problem is shown in FIG. 3 and described below. In one embodiment, the design problem is solved using a Multi-choice Integer Knapsack Algorithm (“MCKNP”).

At 206, it is determined if the design changed based on 204. If no, at 212 the functionality ends and the current design and allocation is the optimized pre-pack solution because the allocation and design can no longer be “improved” in accordance with parameters.

If yes at 208, the changed design is frozen and the allocation of pre-packs to each store is re-optimized. In one embodiment, a “scoring algorithm”, discussed in detail below, is used to re-optimize the allocation based on the new pre-pack design. The functionality then continues at 204.

FIG. 3 is a flow diagram of the functionality of pre-pack optimizer module 16 of FIG. 1 to solve the pre-pack design problem of box 204 of FIG. 2 in accordance with one embodiment. In the embodiment shown in FIG. 3, the MCKNP algorithm is used, but other algorithms may be used in other embodiments. The result of the functionality of FIG. 3 is an optimized pre-pack design which specifies the make-up of each pre-pack type. FIG. 3 determines the design or type for each product “q” in each pre-pack “p”, where p equals 0, 1, 2, . . . n.

At 302, p=0. Allocations are fixed for all pre-pack types. Designs are fixed for all other pre-packs except pre-pack p.

At 304, for each product q in pre-pack p, the potential change in score/cost is computed as disclosed below if the current level a_{pq} is changed by 0, 1, 2 . . . , n units, where n is some predetermined number. “a_{pq}” equals the # of units of sku q in pre-pack type p, and should be within the range (I_{pq}, U_{pq}), as described below.

At 306, a multi-choice integer knapsack problem (MCKNP) is solved for pre-pack p using the costs calculated at 304 for a range of knapsack capacities (e.g., using ACKnap, as disclosed below). The solution to MCKNP predicts the best new quantity for each product in pre-pack p

At 308, a re-allocation (scoring) algorithm, disclosed below, is optionally run to recompute the store allocations for each pre-pack.

At 310, p is incremented by 1.

At 312, it is determined if p equals a maximum (i.e., the maximum number of pre-pack types allowed in a configuration as specified by a hard constraint). If yes at 312, the functionality of FIG. 3 ends. If no at 312, the functionality continues at 304.

As disclosed in FIGS. 2 and 3 above, embodiments determine a good quality pre-pack configuration by attempting to balance the resulting supply with the fine-grain demands for each individual product within the pre-packs at every store in the chain, while also minimizing the total shipping and handling costs. Embodiments allow a user to enter priorities for each of these objectives, and specify constraints such as the quantities of each product with a pre-pack.

Embodiments use a rapid optimization method that works in two phases. In the first phase, the aggregate demand at each store (across all individual products) is determined, and a good pre-pack configuration for this aggregate-product is determined. Next, this solution is utilized to quickly determine a good quality pre-pack configuration whose pre-packs contain a carefully calculated number of units of each product that satisfy all user-specified constraints.

Embodiments consists of two sub problems, each of which on their own are (independently) solvable. Therefore, embodiments alternately and iteratively solve each of these sub problems, with one feeding into and improving the quality of the solution to the other and stop after a fixed number of iterations.

### Inputs

In one embodiment, the following inputs are provided to pre-pack optimizer 16 of FIG. 1:
Minimum and Maximum number of pre-packs (a pair of integers).
SKU store demand (a 2D vector or matrix, which could be a sparse matrix).
Bounds on SKU quantities in each pack (I_{pq}, u_{pq}) for each pre-pack type p, SKU q (all integers).
Bounds on total quantity in each pack (Lₚ, Uₚ) for each pre-pack type p (all integers).
Carton size parameter (e.g., multiples of ‘k’, powers of 2, etc.), all integers or ENUM. An integer list of all feasible pack-size values between (Lₚ, Uₚ) can be directly specified as inputs for each pre-pack type.
Objective function weights or priorities (cᵢ) or soft constraints (all floating point).

### Outputs

In one embodiment, the following outputs are generated by pre-pack optimizer 16 of FIG. 1:
Pack contents 2-D matrix a_{pq}, one entry for each sku-pack combination p, q.
Allocations (xₚⱼ), one entry for each pack-store combination p, j.

### Hard Constraints

In one embodiment, the following hard constraints are received by pre-pack optimizer 16 of FIG. 1 at 202 of FIG. 2:
Min and Max number of pre-pack types in the configuration.
Min and Max number of total units for each pre-pack type. It is possible to specify a unique min/max for each pre-pack type.
Min and max number of units of each sku in each pre-pack type (i.e., range constraints). It is possible to specify a unique pair of values for each sku for every pre-pack type. These range constraints allow fine-grain control over the contents of every pre-pack type (e.g., packs with fringe-sizes only).
Carton-size “ladder”. This specifies the allowable values for the feasible number of total units per pre-pack type. For example, even numbers, multiples of 4, powers of 2, or any integer value.

### Soft Constraints

In one embodiment, the following soft constraints (i.e., business objectives) are received by pre-pack optimizer 16 of FIG. 1 at 202 of FIG. 2:
Minimize a configurable (parameterized) weighted dollar-value measure of total under-allocation (U), over-allocation (O), total number of packs shipped (S) summed across all stores, skus, and pack-types, and a pre-pack type ‘complexity’ cost (c₀), summed across all pre-pack types (P) and is given by:

c₀*P+c₁*U+c₂*O+c₃*S,

where c₀, c₁, c₂, and c₃ are user-specified priority or cost parameters (real numbers). c₃ can be assumed to represent the shipping cost for a single unit, regardless of whether it is a loose unit (eaches) or a pre-pack. U (for a given sku-store combination) is defined as the simple arithmetic difference between the demand (d) minus the allocation of sku-units to a store (A) when A<d, and zero, otherwise, i.e.,
U=Max(0, d−A). Similarly, for a given sku-store combination,
O=Max(0, A-d).

### Optimization Model

In one embodiment, pre-pack optimizer 16 of FIG. 1 uses the following optimization model instead of the alternating heuristic shown in FIGS. 2 and 3. This model assumes the number of pre-pack types is not known in advance.

### Input Data Notation:

d_{jq}=demand for a given sku q at store j.
(m, M)=min and max number of pre-pack pack types allowed.
(Lₚ, Uₚ)=min and max number of units in pre-pack p.
(I_{pq}, u_{pq})=min and max number of units of sku q in pre-pack p.
Z={Z₁, Z₂, . . . , Z_{N}} set of feasible carton-sizes.
c₀=Dollar cost of introducing an additional pre-pack type.
c₁=Dollar cost of one unit of under-allocation of any sku at a store.
c₂=Dollar cost of one unit of over-allocation of any sku at a store.
c₃=Dollar cost of shipping a pre-pack to a store.

### Decision Variables:

xₚⱼ=# of units of pre-pack type p to allocated to store j (integer).
wₚ=binary (indicator) variable that is positive if pre-pack type p is active (chosen) in the optimal solution.
a_{pq}=# of units of sku q in pre-pack type p, and should be within the range (I_{pq}, u_{pq})
For convenient model presentation, an auxiliary decision variables z are used, which are derived from the aggregation of a-variables:
zₚ=# of units in pre-pack type p.

### Mixed-Integer Nonlinear Program:

In one embodiment, the pre-pack planning problem can be expressed as the following nonlinear integer program “PPP”, which includes additional auxiliary variables y⁺, and y⁻ to represent sku-store level under- and over-allocation amounts respectively.

$$PPP \text{:} Minimize {\sum }_{p} {c}_{0} {w}_{p} + {\sum }_{q = 1}^{Q} {\sum }_{j = 1}^{D} ( {c}_{1} {y}_{qj}^{+} + {c}_{2} {y}_{qj}^{-} ) + {c}_{3} {\sum }_{j} {\sum }_{p} {x}_{pj}$$

$$subject to \text{:}$$

$${\sum }_{p} {a}_{pq} {x}_{pj} + {y}_{qj}^{+} - {y}_{qj}^{-} = {d}_{qj } ∀ ( q , j )$$

$${\sum }_{q} {a}_{pq} = {z}_{p} , ∀ p$$

$${l}_{pq} {w}_{p} \leq {a}_{pq} \leq {u}_{pq} {w}_{p}$$

$${L}_{p} {w}_{p} \leq {z}_{p} \leq {U}_{p} {w}_{p}$$

$$m \leq {\sum }_{p} {w}_{p} \leq M$$

$$a , x , y , z , w \geq 0$$

$$z ∈ Z$$

$$x , a integer$$

$$w binary$$

PPP has a hierarchical nature of decision-making (w→z→a→x→y). A consequence of this daisy-chain of decision variables is that the number of possibilities in the solution space increases exponentially in the length of this chain. Further, the bilinear terms (a, x) in the first set of constraints further complicate the model by injecting increased non-convexity into the model. In general, PPP is difficult to solve to optimality, either directly or even indirectly via integer linear reformulations, including generating-set based approaches (e.g., column generation) for many practical instances. Consequently, embodiments use heuristic approaches shown in FIGS. 2 and 3. In general, the number of pre-pack types considered is typically small (less than 10) and thus, it is easier to solve PPP sequentially for each allowed values for the number of pre-pack types in the configuration and select the best solution among these results.

For a fixed number of pre-pack types (i.e., the number of pre-pack types is known in advance):
P=# of pre-pack types in the configuration,

the w-variables and the constraints involving these variables can be eliminated, and the resultant “working model” PPP(P) is shown below.

$$PPP ( P ) \text{:} Minimize {\sum }_{q = 1}^{Q} {\sum }_{j = 1}^{D} ( {c}_{1} {y}_{qj}^{+} + {c}_{2} {y}_{qj}^{-} ) + {c}_{3} {\sum }_{j} {\sum }_{p} {x}_{pj} \\ subject to \text{:} \\ {\sum }_{p} {a}_{pq} {x}_{pj} + {y}_{qj}^{+} - {y}_{qj}^{-} = {d}_{qj } ∀ ( q , j ) \\ {\sum }_{q} {a}_{pq} = {z}_{p} , ∀ p$$

$$a , x , y , z \geq 0$$

$${l}_{pq} \leq {a}_{pq} \leq {u}_{pq}$$

$${L}_{p} \leq {z}_{p} \leq {U}_{p}$$

$$z ∈ Z \\ x , a integer$$

### Multi-choice Integer Knapsack Algorithm Using ACKNAP

As disclosed above in FIG. 3, in one embodiment MCKNP is solved using Advanced Choice Knapsack Problem (“ACKnap”). ACKnap is disclosed, for example, in Pisinger, “ACKnap: An exact algorithm for the Multiple-Choice Knapsack Problem with equality constraints”, herein incorporated by reference in its entirety. The following pseudo-code notation for generic MCKNP instances can be used:

ACKNAP (int_numItems, int_profit[ ][ ], int_weight[ ][ ], int_min_capacity, int_max_capacity, comparator_GLE, boolean_getHistogram, int_profit_table[ ])
This pseudocode notation specifies a profit-maximization optimization problem as follows:

### Given:

1) Number of items (numItems) that can be included in a knapsack.
2) A vector of paired (2-tuple) entries corresponding to each of these items, which represent the profit (objective) at the corresponding weight (amount of knapsack space taken up).
3) The capacity of the knapsack, which can either be a fixed value, or a range of integer values between min_capacity and a max_capacity.
4) A comparison operator (“comparator”) that specifies whether the total usage level (sum of weights) is constrained to be ≦, ==, or ≧the input capacity (or range of capacities).
5) A Boolean control parameter that specifies if an option of finding:
   a. a histogram of optimal profits for a range of capacities (in which case, a profit table is specified to store this output).
   b. The optimal usage levels for each item (in which case, a profit table is not required to be specified)
      Find: the optimal quantity of each item to be included within a knapsack such that the capacity constraint is not violated by the weighted sum of chosen item quantities, and the total profit is maximized.

### Notation:

### Indices:

q=group index, which can be interpreted as corresponding to sku q, q=1, . . . , Q ;
k=index of an item in the q^{th} group, which can be interpreted as corresponding to the number of sku q items; k=0, . . . , K_{q}

### Input Parameters:

f_{qk}=cost associated with k^{th} item from q^{th} group, which can be interpreted as total of over- and under-allocation costs and shipping costs;
g_{qk}=amount of resources used by k^{th} item in q^{th} group, which can be interpreted as the number of sku q items;
G=the upper bound on the total resources available, which is interpreted as the upper boundary of the pre-pack size.

### Variables:

V_{qk}=1, if k^{th} item was selected from q^{th} group; =0, otherwise.

### Formulation:

$$MCKP \text{:} min {\sum }_{qk} {f}_{qk} {v}_{qk}$$

$$subject to \text{:}$$

$${\sum }_{qk} {g}_{gk} {v}_{qk} \leq G$$

$$∀ q \text{:} {{\sum }_{k = 0}}^{{K}_{q}} {v}_{qk} = 1$$

$${v}_{qk} ∈ \{ 0 , 1 \}$$

### Finding an Initial Feasible Solution that Meets all Hard Constraints

In one embodiment, an initial feasible solution determines a good value for the total number of SKU units in each pre-pack type (z-variables in PPP) such that a good match is obtained between total sku-parent level demand and pre-packs. Toward this, the PPP is solved at a higher-level of demand aggregation, i.e., solve a single sku-parent level problem whose store-level demand=sum of all SKU-level demands for that store, as shown below.

$$1 - PPP \text{:} Minimize {\sum }_{j = 1}^{{D}^{′}} ( {c}_{1} {y}_{j}^{+} + {c}_{2} {y}_{j}^{-} ) + {c}_{3} {\sum }_{j} {\sum }_{p} {x}_{pj} \\ subject to \text{:}$$

$${\sum }_{p} {z}_{p} {x}_{pj} + {y}_{j}^{+} - {y}_{j}^{-} = {\sum }_{q} {d}_{qj } ∀ j$$

$$x , y , z \geq 0$$

$${L}_{p} \leq {z}_{p} \leq {U}_{p}$$

$$z ∈ Z$$

$$x , z integer$$

Advantages in choosing this formulation include:
There are usually a number of stores having the same aggregate demand value. Such stores can be aggregated into a single store. Typically this leads to a factor of 10-50 reduction in the store-dimension (D′˜0.05D) and results in a problem (1×D′) that is much smaller in comparison to the original (Q×D) in the number of decision variables.
The scoring algorithm can be simplified as well as speeded up, without sacrificing optimality. This is done by calling ACKNAP for each store and solving a particularly small multi-choice knapsack problem.

### Improving a Pre-Pack Configuration while Meeting Hard Constraints Using ACKNAP

In one embodiment, once the initial feasible solution is generated, the heuristic approach of FIGS. 2 and 3 is used to arrive at an improved configuration. In one embodiment, to iteratively improve an existing feasible solution to Problem PPP above, the following restriction R(p) is imposed:
a) fix the x-variables for all pre-packs at their current values;
b) fix the a-variables for all but one pre-pack (p) at their current values.
   This restriction allows ACKNAP to be used to generate bulk improvements as follows:
1. p=1
2. Determine the optimal values for a_{pq} for PPP under restriction R(p). This is done by solving for all feasible values of zₚ (knapsack capacities) by invoking ACKNAP in the variable capacity mode to generate a histogram of the optimal objective function values:
   a. ACKNAP (Q, score, weight, Lₚ, Uₚ, EQUAL_TO, true, profit_table)
      At this stage the multiple choice knapsack problem is formed and solved to compute the values of a_{pq} that minimize the objective function of PPP (that is, misallocation) with all x-variables and a_{p′j}, p′≠p fixed.
      Using the notation from the MCKP formulation above, perform the following settings:

K_{pq}=U_{pq}−I_{pq};

$${f}_{qk} = {\sum }_{j = 1}^{D} ( {c}_{1} {y}_{qj}^{+} + {c}_{2} {y}_{qj}^{-} )$$

where y-variables are determined from formulation PPP(P) by setting a_{pq}=k+I_{pq}, k=0, . . . , K_{q} and using fixed values of x-variables;

g_{qk}=k+I_{pq}

G=Uₚ
If instead of a simple upper bound on the pack p size, there is a pre-pack size ladder Zp, then replace the first constraint in MCKP formulation with

$${\sum }_{qk} {g}_{qk} {v}_{qk} ∈ {Z}_{p}$$

As shown, after solving the (MCKP) with the above coefficient settings, the values of a_{pq} determined as

$${a}_{pq} = {\sum }_{qk} {f}_{qk} {v}_{qk}$$

do minimize the objective function PPP(P) with all x-variables and a_{p′j}, p′≠p, fixed
If there is a known set of feasible variables (a, x, y), then values for the f coefficients in the knapsack formulation, can be obtained somewhat faster by the following procedure:

set Δ⁺ₖ=k−a_{pq} for all k>a_{pq} and Δₖ⁻=a_{pq}−k for all k<a_{pq};
then

$${f}_{qk} = \{ \begin{matrix}∀ k > {a}_{pq} \text{:} {\sum }_{j = 1}^{D} ( {c}_{1} max ( {Δ}_{k}^{+} {x}_{pj} - {y}_{qj}^{-} , 0 ) - {c}_{2} min ( {Δ}_{k}^{+} {x}_{pj} , {y}_{qj}^{-} ) ) \\ ∀ k > {a}_{pq} \text{:} {\sum }_{j = 1}^{D} ( {c}_{2} max ( {Δ}_{k}^{-} {x}_{pj} - {y}_{qj}^{+} , 0 ) - {c}_{1} min ( {Δ}_{k}^{-} {x}_{pj} , {y}_{qj}^{+} ) ) \\ 0 , otherwise\end{matrix}$$

b. Determine optimal and carton-feasible capacity z̅hd p and a_{pq} values based on this profit_table histogram as the solution delivering the least cost subject to the pack size constraints.

### Scoring Algorithm

In one embodiment, a score/cost for each pre-pack p is determined, such as shown in 304 of FIG. 3 above. Given a fixed pre-pack configuration, this scoring algorithm determines the optimal allocation of each pack-type sequentially by store. The problem for scoring algorithm ‘A’ can be formulated as

$$Allocation \text{:} Minimize {\sum }_{q = 1}^{Q} {\sum }_{j = 1}^{D} ( {c}_{1} \cdot {y}_{qj}^{+} + {c}_{2} \cdot {y}_{qj}^{-} ) + {c}_{3} {\sum }_{j} {\sum }_{p} {x}_{pj}$$

$$subject to \text{:}$$

$${\sum }_{p} {a}_{pq} {x}_{pj} + {y}_{qj}^{+} - {y}_{qj}^{-} = {d}_{qj} ∀ ( q , j )$$

$${y}_{qj} \geq 0 , ∀ q , j$$

$${x}_{pj} \geq 0 and integer ∀ p , j$$

$${x}_{pj} ∈ {X}_{j}$$

where Xⱼ is a feasible set of assignment variables associated with store j. It may be determined by such constraints as shipping minimum, presentation maximum, and over-allocation limit. These constraints can be expressed as:

$${\sum }_{q = 1}^{Q} {\sum }_{p} {a}_{pq} {x}_{pj} \geq {S}_{j}$$

$${\sum }_{q = 1}^{Q} {\sum }_{p} {a}_{pq} {x}_{pj} \leq {P}_{j}$$

$${\sum }_{q = 1}^{Q} max ( {\sum }_{p} {a}_{pq} {x}_{pj} - {d}_{qj} , 0 ) \leq {O}_{j}$$

where Sⱼ, Pⱼ, and Oⱼ are shipping minimum, presentation maximum and over-allocation limit, respectively, for store j.
Other, more exotic per-store constraints may be present in the formulation.
Since the problem does not have inter-store binding constraints, it can be easily decomposed to be solved on a per-store basis. The per-store allocation problem then becomes:

$$Allocation per store j \text{:} Minimize {\sum }_{q = 1}^{Q} ( {c}_{1} \cdot {y}_{qj}^{+} + {c}_{2} \cdot {y}_{qj}^{-} ) + {c}_{3} {\sum }_{p} {x}_{pj}$$

$$subject to \text{:}$$

$${\sum }_{p} {a}_{pq} {x}_{pj} + {y}_{qj}^{+} - {y}_{qj}^{-} = {d}_{qj} ∀ ( q , j )$$

$${y}_{qj} \geq 0 , ∀ q , j$$

$${x}_{pj} \geq 0 and integer ∀ p , j$$

$${x}_{pj} ∈ {X}_{j}$$

Since the number of pre-pack types is typically relatively low (at most 10) in some embodiments, the solution to the per-store allocation problem can be obtained by “almost” complete enumeration, which means that in the worst case all feasible solutions will be generated in order to select the optimal solution. However, a number of filters can be applied that significantly reduce the number of the solutions to generate. The solution process starts with x-vector with all zeroes and goes through P iterations. At iteration p, the set of current vectors is doubled by adding vectors with 1 in the p-th position to the vectors in the current set, which by design have 0 in the p-th position. Then the filters are applied and the process reiterates by adding vectors with 1 in the p+1 position. There are three groups of filters that are applied with the objective function and constraints in one embodiment as described below:
1. Current infeasibility filter: If either presentation maximum or over-allocation limit constraint is violated for a store allocation vector, they will be also violated for all its descendants generated by adding more 1's.
2. Sub-optimality filter: If all y⁻=0, i.e., there is no under-allocation and c₂+c₃>0, then all future descendants of the store allocation vector will have higher cost and thus be suboptimal.
3. Shipping minimum filter: If at iteration p′ the following is true:

$${\sum }_{q = 1}^{Q} {\sum }_{p = 1}^{{p}^{′}} {a}_{pq} {x}_{pj} + {\sum }_{q = 1}^{Q} {\sum }_{p = {p}^{′} + 1}^{P} {a}_{pq} < {S}_{j} ,$$

then this vector and all descendants are infeasible.

The above procedure assumed that the solution x-vector is binary, which in general may not be practical, as more than one pack of the same type can be allocated to a store. In order to apply the solution approach to the case of general integer variables, each original integer x-variable can be expressed as:

$${x}_{pj} = {\sum }_{k = 0}^{{log}_{2} {d}_{j}} {2}^{k} {x}_{pj}^{k} , {x}_{pj}^{k} ∈ \{ 0 , 1 \} , ∀ p = 1 , … , T , j = 1 , … , D .$$

where dⱼ=max_{qj}. As shown, for a given value of integer x-variable there is a single set of binary variables that satisfy the above equation.

Finally, in addition to the optimal solution for the Allocation problem the algorithm can potentially return a set of all feasible allocations that can be further used to find overall optimal allocation subject to a limited single resource such as total number of packs or total buy.

### Single SKU and Fixed Pre-Pack Scoring Algorithm

In one embodiment, an optimal scoring algorithm is used that works only for the single-sku case (“1-PPP”) and a fixed pre-pack configuration (all z-variables fixed). This restricted 1-PPP instance can be solved to optimality by sequentially optimizing the resultant (independent) store-level allocation problems. In the 1-PPP embodiment, such store-level problems can be determined via a pair of multi-choice knapsack problems:
a) Maximize weighted sum of P pre-pack allocations minus the total packs shipped, subject to sum of allocations not exceeding store-demand. This is solved via:

ACKNAP (P, score, weight, demand, demand, LESS_EQUALS, false, empty_table)
b) Minimize weighted sum of P pre-pack allocations and total packs shipped, subject to the sum of allocations being at least equal to the store-demand. This is solved via:

ACKNAP (P, score, weight, demand, demand, GREATER_EQUALS, false, empty_table).

Since ACKNAP runs in pseudo-polynomial time and is efficiently implemented, this approach is usually faster than the largely enumerative approach of the previously described algorithm for a single-sku case (in the absence of any LP/MIP solver).

### Setting Up the ACKnap Formulation for a Store

In one embodiment, for any pre-pack p, the score associated with the variable xₚⱼ is computed. For the first algorithm above, the following problem is solved:

$$U ( j ) : Maximize {\sum }_{p = 1}^{P} ( {c}_{1} {\overline{z}}_{p} {x}_{p} - {c}_{3} {x}_{p} )$$

$$subject to \text{:}$$

$${\sum }_{p} {\overline{z}}_{p} {x}_{p} \leq ⌊ d ⌋$$

$$x ∈ X$$

Where X represents the feasible set of x-values to consider for each item, and z̅ₚ is the current (fixed) number of units in pack p. For the second algorithm above, the following is solved:

$$O ( j ) : Minimize {\sum }_{p = 1}^{P} ( {c}_{2} {\overline{z}}_{p} {x}_{p} + {c}_{3} {x}_{p} )$$

$$subject to \text{:}$$

$${\sum }_{p} {\overline{z}}_{p} {x}_{p} \geq ⌈ d ⌉$$

$$x ∈ X$$

By substituting variables by their complements: wₚⱼ=Uₚⱼ−xₚⱼ, that define the set W, and where U is a pre-calculated upper bound on x, the above can be transformed to an equivalent, convenient form like U(j):

$${O}^{′} ( j ) : Maximize {\sum }_{p = 1}^{P} ( {c}_{2} {\overline{z}}_{p} {w}_{p} + {c}_{3} {w}_{p} )$$

$$subject to \text{:}$$

$${\sum }_{p} {\overline{z}}_{p} {w}_{p} \leq {\sum }_{p} {\overline{z}}_{p} {U}_{p} - ⌈ d ⌉$$

$$w ∈ W$$

As disclosed, embodiments first decide on an optimal number of units in each pre-pack type and then finds a good assignment of sku units to each pre-pack type. This initial solution is further improved based on how it allocates at the sku-level via calls to the allocation solver. This heuristic procedure rapidly solves a sequence of multi-choice integer knapsack problems. Embodiments can find a solution starting with a fixed or variable number of pre-pack types.

Embodiments determine a good quality pre-pack configuration by attempting to balance the resulting supply with the fine-grain demands for each individual product within the pre-packs at every store in the chain, while also minimizing the total shipping and handling costs. Embodiments of the present invention do not require commercial math libraries to efficiently solve such a rule-constrained business optimization problems. Instead, a multi-choice knapsack approach is used to solve both levels of problems. Further, embodiments provides a user-friendly approach to business decision optimization that is minimally disruptive, in that a user only works with business rules and logical priorities that they are familiar with, rather than being forced to enter numerical weights as inputs and encounter unintuitive answers as outputs.

Further, embodiments, by balancing supply with the best available forecast of fine-grain demand (i.e., for each product at each store), can very closely balance supply and demand, while also keeping shipping cost to a minimum. Embodiments allow a user to input plausible demand fluctuations and thereby prevent the pre-pack design from being “keyed into” a particular demand snapshot.

Several embodiments are specifically illustrated and/or described herein. However, it will be appreciated that modifications and variations of the disclosed embodiments are covered by the above teachings and within the purview of the appended claims without departing from the spirit and intended scope of the invention.

What is claimed is:

1. A computer readable medium having instructions stored thereon that, when executed by a processor, causes the processor to determine an optimized pre-pack allocation and optimized pre-pack designs, the determine comprising:
(a) receive demand data and constraints;
(b) initialize a current pre-pack allocation and a current pre-pack design;
(c) for the current pre-pack allocation, determine a new pre-pack design by solving a multi-choice integer knapsack problem;
(d) determine if the new pre-pack design is different than the current pre-pack design;
(e) when the new pre-pack design is the same as the current pre-pack design, assign the new pre-pack design as the optimized pre-pack design and the current pre-pack allocation as the optimized pre-pack allocation; and
(f) when the new pre-pack design is different than the current pre-pack design, determine a new pre-pack allocation and assign the new pre-pack allocation as the current pre-pack allocation and the new pre-pack design as the current pre-pack design and repeat (c)-(f).

2. The computer readable medium of claim 1, wherein the determine the new pre-pack design by solving the multi-choice integer knapsack problem comprises:
(a) select a first pre-pack p of a plurality of pre-packs of the current pre-pack allocation, while fixing designs of the remaining pre-packs;
(b) for each product q in first pre-pack p, compute a potential change in a cost if a current level a_{pq} is changed by 0, 1, 2 . . . , n units, wherein n is a predetermined number;
(c) solve the multi-choice integer knapsack problem for first pre-pack p using a determined costs for a range of knapsack capacities to determine a new design for first pre-pack p; and
repeat (a)-(c) for each of the other pre-packs of the plurality of pre-packs.

3. The computer readable medium of claim 1, wherein the multi-choice integer knapsack problem is solved using an Advanced Choice Knapsack Problem.

4. The computer readable medium of claim 2, wherein the compute the potential change in the cost comprises solving an allocation algorithm comprising:
$$Allocation \text{:} Minimize {\sum }_{q = 1}^{Q} {\sum }_{j = 1}^{D} ( {c}_{1} \cdot {y}_{qj}^{+} + {c}_{2} \cdot {y}_{qj}^{-} ) + {c}_{3} {\sum }_{j} {\sum }_{p} {x}_{pj}$$
$$subject to \text{:}$$
$${\sum }_{p} {a}_{pq} {x}_{pj} + {y}_{qj}^{+} - {y}_{qj}^{-} = {d}_{qj} ∀ ( q , j )$$
$${y}_{qj} \geq 0 , ∀ q , j$$
$${x}_{pj} \geq 0 and integer ∀ p , j$$
$${x}_{pj} ∈ {X}_{j}$$

5. The computer readable medium of claim 1, wherein at the initialize, a number of pre-pack types is variable.

6. The computer readable medium of claim 1, wherein at the initialize, a number of pre-pack types is fixed.

7. The computer readable medium of claim 1, wherein the pre-pack design comprises a make-up of each of a plurality of pre-pack types, wherein the make-up comprises a quantity of each of a plurality of stock keeping units.

8. The computer readable medium of claim 7, wherein the optimized pre-pack allocation comprises a number of units of each of the pre-pack types allocated to each of a plurality of stores.

9. The computer readable medium of claim 1, wherein the constraints comprise hard constraints and soft constraints.

10. A computer implemented method to determine an optimized pre-pack configuration comprising an optimized pre-pack allocation and an optimized pre-pack design, the method comprising:
receiving demand data and constraints;
initializing a current pre-pack allocation and a current pre-pack design;
for the current pre-pack allocation, determining a new pre-pack design by solving a multi-choice integer knapsack problem;
determining if the new pre-pack design is different than the current pre-pack design;
when the new pre-pack design is different than the current pre-pack design, determining a new pre-pack allocation and assigning the new pre-pack allocation as the current pre-pack allocation and the new pre-pack design as the current pre-pack design and repeating the determining the new pre-pack design and the determining if the new pre-pack design is different than the current pre-pack design until the new pre-pack design is the same as the current pre-pack design; and
when the new pre-pack design is the same as the current pre-pack design, assigning the new pre-pack design as the optimized pre-pack design and the current pre-pack allocation as the optimized pre-pack allocation.

11. The method of claim 10, wherein the determining the new pre-pack design by solving the multi-choice integer knapsack problem comprises:
selecting a first pre-pack p of a plurality of pre-packs of the current pre-pack allocation, while fixing designs of the remaining pre-packs;
for each product q in first pre-pack p, computing a potential change in a cost if a current level a_{pq} is changed by 0, 1, 2 . . . , n units, wherein n is a predetermined number;
solving the multi-choice integer knapsack problem for first pre-pack p using a determined costs for a range of knapsack capacities to determine a new design for first pre-pack p; and
repeat the selecting, computing and solving for each of the other pre-packs of the plurality of pre-packs.

12. The method of claim 10, wherein the multi-choice integer knapsack problem is solved using an Advanced Choice Knapsack Problem.

13. The method of claim 11, wherein the computing the potential change in the cost comprises solving an allocation algorithm comprising:
$$Allocation \text{:} Minimize {\sum }_{q = 1}^{Q} {\sum }_{j = 1}^{D} ( {c}_{1} \cdot {y}_{qj}^{+} + {c}_{2} \cdot {y}_{qj}^{-} ) + {c}_{3} {\sum }_{j} {\sum }_{p} {x}_{pj}$$
$$subject to \text{:}$$
$${\sum }_{p} {a}_{pq} {x}_{pj} + {y}_{qj}^{+} - {y}_{qj}^{-} = {d}_{qj} ∀ ( q , j )$$
$${y}_{qj} \geq 0 , ∀ q , j$$
$${x}_{pj} \geq 0 and integer ∀ p , j$$
$${x}_{pj} ∈ {X}_{j}$$

14. A system for determining an optimized pre-pack configuration that comprises an optimized pre-pack allocation and an optimized pre-pack design, the system comprising:
a processor;
a computer-readable medium coupled to the processor and comprising instructions that cause the processor to:
receive demand data and constraints;
initialize a current pre-pack allocation and a current pre-pack design;
for the current pre-pack allocation, determine a new pre-pack design by changing a quantity level of each of a product in a pre-pack type;
determine if the new pre-pack design is different than the current pre-pack design;
when the new pre-pack design is different than the current pre-pack design, determine a new pre-pack allocation and assign the new pre-pack allocation as the current pre-pack allocation and the new pre-pack design as the current pre-pack design and repeating the determine the new pre-pack design and the determine if the new pre-pack design is different than the current pre-pack design until the new pre-pack design is the same as the current pre-pack design; and
when the new pre-pack design is the same as the current pre-pack design, assigning the new pre-pack design as the optimized pre-pack design and the current pre-pack allocation as the optimized pre-pack allocation.

15. The system of claim 14, wherein the determine the new pre-pack design comprises solving a multi-choice integer knapsack problem.

16. The system of claim 15, wherein the solving the multi-choice integer knapsack problem comprises:
selecting a first pre-pack p of a plurality of pre-packs of the current pre-pack allocation, while fixing designs of the remaining pre-packs;
for each product q in first pre-pack p, computing a potential change in a cost if a current level a_{pq} is changed by 0, 1, 2 . . . , n units, wherein n is a predetermined number;
solving the multi-choice integer knapsack problem for first pre-pack p using a determined costs for a range of knapsack capacities to determine a new design for first pre-pack p; and
repeat the selecting, computing and solving for each of the other pre-packs of the plurality of pre-packs.

17. The system of claim 16, wherein the multi-choice integer knapsack problem is solved using an Advanced Choice Knapsack Problem.

18. The system of claim 16, wherein the computing the potential change in the cost comprises solving an allocation algorithm comprising:
$$Allocation \text{:} Minimize {\sum }_{q = 1}^{Q} {\sum }_{j = 1}^{D} ( {c}_{1} \cdot {y}_{qj}^{+} + {c}_{2} \cdot {y}_{qj}^{-} ) + {c}_{3} {\sum }_{j} {\sum }_{p} {x}_{pj}$$
$$subject to \text{:}$$
$${\sum }_{p} {a}_{pq} {x}_{pj} + {y}_{qj}^{+} - {y}_{qj}^{-} = {d}_{qj} ∀ ( q , j )$$
$${y}_{qj} \geq 0 , ∀ q , j$$
$${x}_{pj} \geq 0 and integer ∀ p , j$$
$${x}_{pj} ∈ {X}_{j}$$
